(19) United States
(12) Patent Application Publication
(10) Pub. No.: US 2019/0044618 A1
(43) Pub. Date: Feb. 7, 2019

(54) A Receiver For Data Communications, A Receiver System, And A Data Communications System

(71) Applicant: OXFORD UNIVERSITY INNOVATION LIMITED, Oxford Oxfordshire (GB)

(72) Inventor: Steve COLLINS, Oxford Oxfordshire (GB)

(21) Appl. No.: 16/074,483

(22) PCT Filed: Feb. 2, 2017
(86) PCT No.: PCT/GB2017/050254

§ 371 Date: Aug. 1, 2018

(30) Foreign Application Priority Data
Feb. 3, 2016 (GB) 1601934.1

(51) Int. Cl. H04B 10/572; H04B 10/116

(52) U.S. Cl. CPC H04B 10/572; H04B 10/116

(57) ABSTRACT

Data communications receiver having a first stage that receives radiation via a first input surface and outputs concentrated radiation via one or more first output surfaces. The first stage has a first wavelength converting element that converts radiation to longer wavelength radiation. One or more first detectors detect radiation output from the first concentration stage. A second stage receives radiation via one or more second input surfaces and outputs radiation via one or more second output surfaces. The second stage has a second wavelength converting element that converts radiation to longer wavelength radiation. Second detector(s) detect radiation output from the second stage. The first and second stages are arranged relative to each other such that a shadowing of the first stage by the second stage in respect of radiation incident on the receiver varies as a function of a direction of incidence of the incident radiation.

Market research published in 2014 predicted that by 2019 there will be 11.5 billion mobile-connected devices in the world and that these devices will contribute to a tenfold increase in global mobile data traffic between 2014 and 2019. It is anticipated that high concentrations of devices using the RF spectrum will generate so much interference that service quality will be significantly degraded. A key part of the solution to this expected spectrum crunch is to exploit new parts of the electromagnetic spectrum to support mobile wireless communications.

A part of the electromagnetic spectrum not currently used widely for wireless communications is visible light. The possibility of exploiting this part of the spectrum economically is increasing, due to the growing use of light emitting diodes (LEDs) for lighting. Unlike some other lighting technologies, LEDs can be modulated at relatively high frequencies. For example, micro-LEDs can be modulated at frequencies up to 185 MHz. These frequencies are suitable for wireless communications using existing infrastructure. Other potential advantages of visible light communication (VLC) include the lack of electromagnetic interference, the ability to localise light within a space to support many users and the improved cyber-security arising from the fact that light does not penetrate walls.

For indoor VLC lighting LEDs can be used as transmitters with a high signal to noise ratio. Receivers will each need to incorporate a photodetector which converts the modulated light into a modulated electrical signal. To have a large enough bandwidth the photodetectors will typically have to be fairly small (possibly of the order of 100-300 μm diameter). The signal falling on such small photodetectors may be increased using an optical concentrator such as a lens or a compound parabolic concentrator. However, the area of typical concentrators is limited by the conservation of étendue (constant radiance theorem), which means that the maximum gain, Gₘₐₓ, for a concentrator with a field of view θ is given by

$${G}_{ma x} = \frac{{n}^{2}}{{sin}^{2} θ} ,$$

where n is the refractive index of the concentrator.

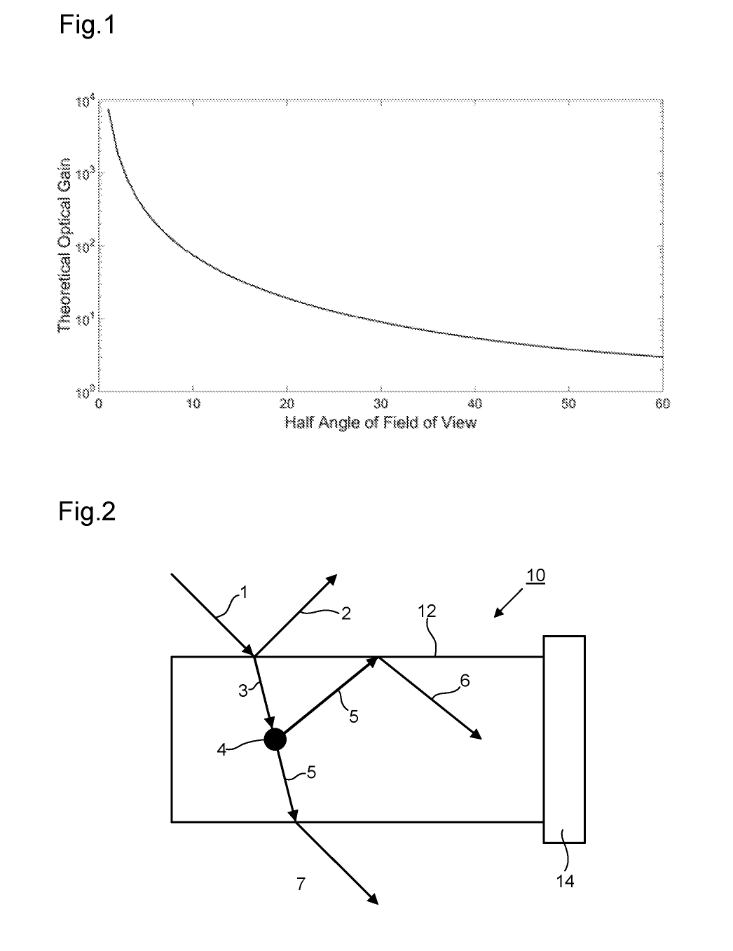

The relationship between the étendue limited maximum theoretical optical gain and the half angle of the field of view of a concentrator is shown in FIG. 1. This shows that gains of 1,000 are possible. However, with gains at this level the concentrator's aperture will have a diameter of less than 1 cm. Such small apertures will be vulnerable to being accidentally blocked. Furthermore, the high gain reduces the field of view (FOV). A gain of around 1,000 will be associated with a FOV of about 3°. This is likely to cause problems in many practical applications. For example, if VLC were to be used with handheld mobile terminals such as mobile phones or tablets, these would need to have concentrators with relatively large fields of view, for example around 20° or higher. Such fields of view would reduce the maximum theoretical gain of the concentrator to below 20. Unfortunately, a concentrator with a field of view of 20° or more will also have an aperture of 1 mm or less, and will therefore be vulnerable to blocking.

Changing the wavelength of radiation during the concentration process, using fluorescence for example, allows gains and/or fields of view to be achieved which are not constrained by conservation of étendue, and which can therefore be more favourable. Examples of arrangements based on this principle are disclosed for example in GB 2506383A and in ‘High gain, wide field of view concentrator for optical communications’, Steve Collins, Dominic C. O'Brien and Andrew Watt, OPTICS LETTERS, Vol. 39, No. 7, pp1756-1759 Apr. 1, 2014.

The principle of operation of a concentrator 10 comprising a wavelength converting element based on fluorescence is illustrated schematically in FIG. 2. Light 1 from a transmitter is incident on the front surface 12 of the concentrator 10, which acts as a collecting area of the concentrator 10. Some of this incident light will be reflected from the surface 10 (arrow 2) but most of the light will be transmitted into the concentrator 10 (arrow 3). Some of transmitted incident light will be absorbed by fluorophores 4 within the concentrator 10. Any fluorophore that has been excited by a photon of incident light might emit a photon with a longer wavelength in a random direction (arrows 5). Some of this emitted light will escape from the concentrator 10 (arrow 7) but most of it will be retained with the concentrator 10 by total internal reflection (arrow 6). If re-absorption by the fluorophore at the new wavelength is negligible this light will reach a detector 14 at an edge of the concentrator 10. Even if the retained light is absorbed by the fluorophore before it reaches the detector 14 it can still be emitted at an even longer wavelength, be retained by total internal reflection and reach the detector 14.

The performance of the concentrator 10 can be characterised by the effective photon concentrator factor (EPCF). If the probability of transmission into the concentrator is T, the probability of the incident light being absorbed by the fluorophore is Fᵢ, the quantum yield is Q_{y} and the probability of being retained and not re-absorbed is Fᵣ then the EPCF is given by

$$EPCF = T \times {F}_{i} \times {Q}_{y} \times {F}_{r} \times \frac{L}{t} ,$$

where L and t are respectively the length and the thickness of the concentrator 10. This assumes that any re-absorbed photons are lost. If re-absorption is significant this equation will give an underestimate of the EPCF.

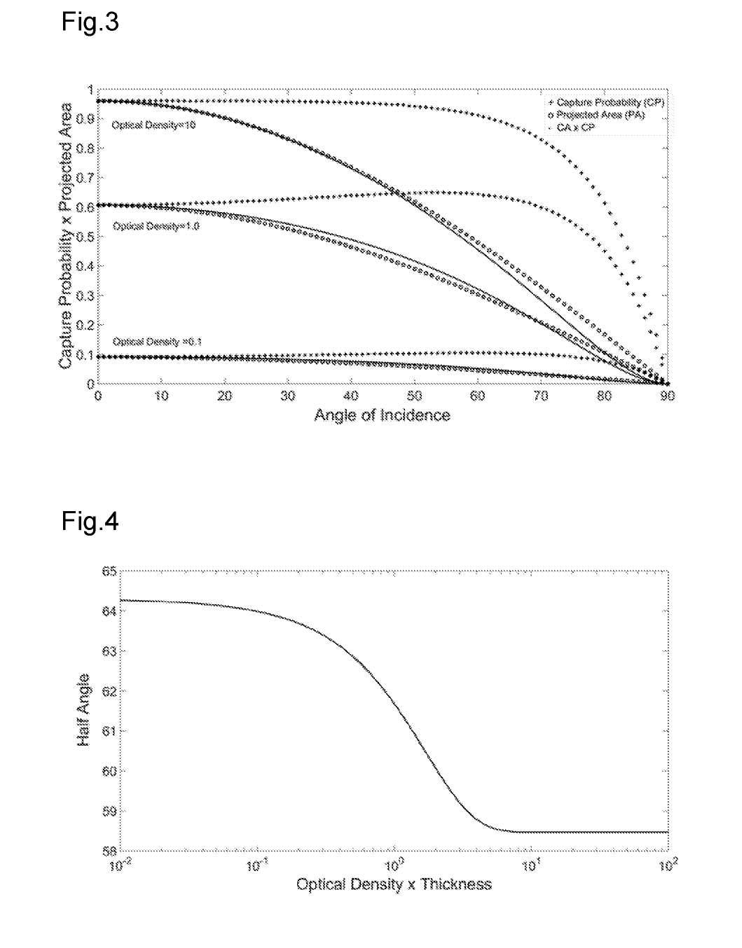

The FOV of the concentrator 10 is determined by a combination of the angular dependences of the probability of transmission through the front surface 12, the probability of absorption, which varies because of changes in the path length in the concentrator 10, and the effective area of the concentrator 10 as seen from the transmitter. FIG. 3 shows the capture probability (CP (θ)=T(θ).Fi(θ)), the projected area (CP(0).cos(θ)) and the product of these two phenomena at different angles of incidence for three different optical densities. For all optical densities the angular dependence of the projected area dominates the angle of incidence dependence of the receiver. It can furthermore be seen that for different optical densities of fluorophore CP(θ) is almost independent of the angle of incidence if it is less than 60°. As also shown in

FIG. 3, this means that the FOV will be largely determined by the effective area of the concentrator 10, which means that the expected angular dependence of the gain of the concentrator can be estimated using the expression Gain(θ)=Gain(0)×cos(θ), where θ is the angle of incidence. This simple expression would suggest that the angle at which the gain of the concentrator 10 decreases by a factor of two is 60°. FIG. 4 shows that, although the angle at which the gain decreases by a factor of 2 depends upon the optical density of the fluorophore, it only changes from 64.3° to 58.5°. The maximum theoretical gain for a conventional étendue limited concentrator with a FOV of 60° is 3. An optical concentrator 10 with a FOV of 60° only needs a gain of more than 3 to compete with a conventional concentrator.

It has proven challenging to implement a VLC system for plural mobile terminals that achieves a reliable uplink connection from the terminals while keeping transmission intensities from the terminals low enough that they are not unpleasantly bright or dazzling. This is the case even where gain or FOV in the terminals or in the uplink receiver is improved using fluorescence as discussed above.

It is an object of the invention to provide an improved receiver for free space optical communications, including visible light communications.

According to an aspect of the invention, there is provided a receiver for data communications, comprising: a first concentration stage configured to receive radiation via a first input surface and output concentrated radiation via one or more first output surfaces, the first concentration stage comprising a first wavelength converting element configured to convert radiation to longer wavelength radiation; one or more first detectors configured to detect radiation output from the first concentration stage; a second concentration stage configured to receive radiation via one or more second input surfaces and output radiation via one or more second output surfaces, the second concentration stage comprising a second wavelength converting element configured to convert radiation to longer wavelength radiation; and one or more second detectors configured to detect radiation output from the second concentration stage, wherein the first and second concentration stages are arranged relative to each other such that a shadowing of the first concentration stage by the second concentration stage in respect of radiation incident on the receiver varies as a function of a direction of incidence of the incident radiation, thereby causing a corresponding variation in the radiation detected by the first and second detectors as a function of the direction of incidence.

The shadowing of one concentration stage using another concentration stage allows the receiver to distinguish between radiation from different directions (and therefore from different transmitters) with minimal loss of overall signal. Multiple transmitters can thus reliably communicate with the receiver without the signal from the transmitters needing to be too intense, which can undesirably lower battery life and/or, in the case where the transmitted radiation is in the visible band, risk unpleasant dazzling effects during transmission.

In an embodiment, the second concentration stage comprises a plurality of concentration elements that each have at least a portion with an elongate cross-section when viewed in a direction parallel to at least a portion of the first input surface that is closest to the cross-section; and an axis of elongation of the elongate cross-section is within 20 degrees of perpendicular to a closest portion of a first input surface.

This arrangement provides particularly effective direction of incidence dependent shadowing. In an embodiment, the receiver further comprises a third concentration stage configured to receive radiation via one or more third input surfaces and output radiation via one or more third output surfaces, the third concentration stage comprising a third wavelength converting element configured to convert radiation to longer wavelength radiation, and one or more third detectors configured to detect radiation output from the third concentration stage, wherein the third concentration stage is arranged relative to the first and second concentration stages such that a shadowing of either or both of the first and second concentration stages by the third concentration stage in respect of radiation incident on the receiver varies as a function of the direction of incidence of the incident radiation, thereby causing a corresponding variation in the radiation detected by the first, second and third detectors. Optionally, the variation as a function of direction of incidence of the shadowing by the second concentration stage is different to the variation as a function of direction of incidence of the shadowing by the third concentration stage.

The third concentration stage helps to provide more detailed information about the direction of incidence of radiation on the receiver, thereby helping to distinguish more reliably and effectively between radiation from different sources.

In an embodiment, the one or more second input surfaces comprise plural sets of second input surfaces, each set of second input surfaces comprising one or more second input surfaces, the second wavelength converting element is configured to convert radiation input through a first set of the plural sets of second input surfaces to longer wavelength radiation that is predominantly of a first type, the second wavelength converting element is configured to convert radiation input through a second set of the plural sets of second input surfaces to longer wavelength radiation that is predominantly of a second type, different from the first type, the relative proportion of longer wavelength radiation of the first type to longer radiation of the second type detected by the one or more second detectors varies as a function of the direction of incidence of the incident radiation.

Varying the radiation conversion as a function of the direction of incidence of the radiation helps further to distinguish reliably and effectively between radiation from different sources.

Embodiments of the invention will now be described, by way of example only, with reference to the accompanying drawings in which corresponding reference symbols represent corresponding parts, and in which:

FIG. 1 depicts a relationship between an étendue limited maximum gain and the half angle of the field of view of a concentrator;

FIG. 2 depicts the principle of operation of a concentrator having a wavelength converting element based on fluorescence;

FIG. 3 depicts the angular variation of the capture probability, the projected area, and the product of capture probability and projected area, for a concentrator of the type depicted in FIG. 2;

FIG. 4 depicts the variation of the angle at which the gain decreases by a factor of 2 as a function of the product of optical density of the fluorophore and thickness of the wavelength converting element;

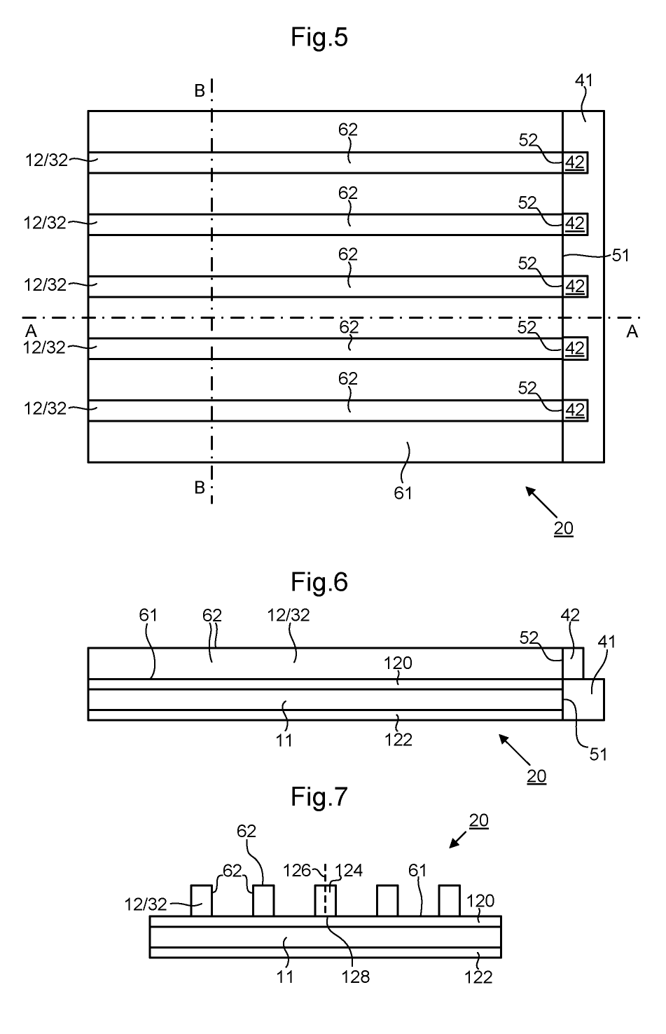

FIG. 5 is a schematic top view of a receiver for data communications according to an embodiment;

FIG. 6 is a schematic side sectional view along A-A in FIG. 5;

FIG. 7 is a schematic side sectional view along B-B in FIG. 5;

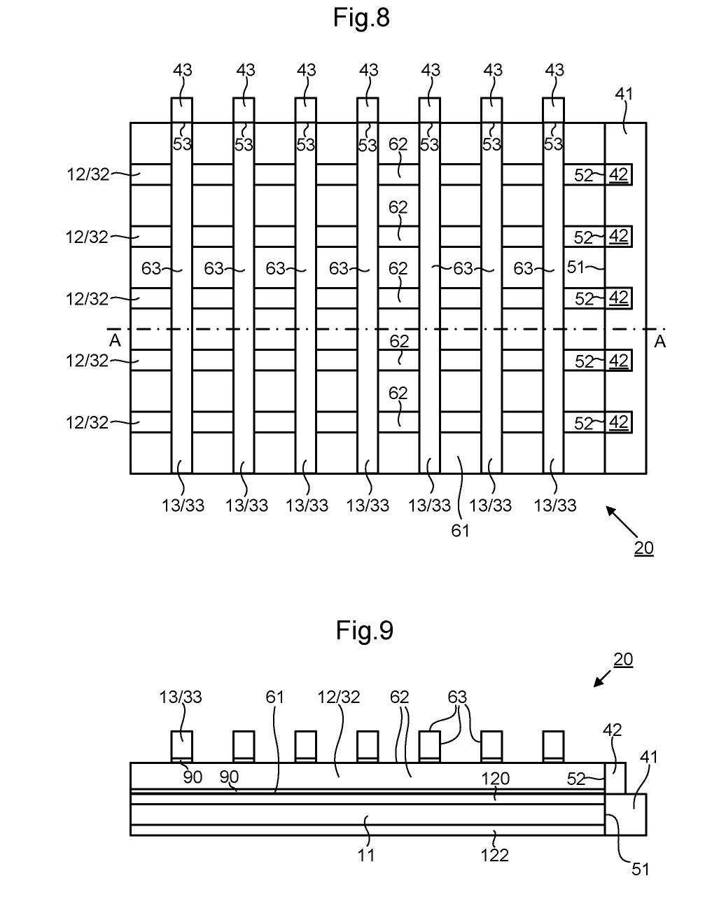

FIG. 8 is a schematic top view of a receiver for data communications further comprising a third concentration stage;

FIG. 9 is a schematic side sectional view along line A-A in FIG. 8;

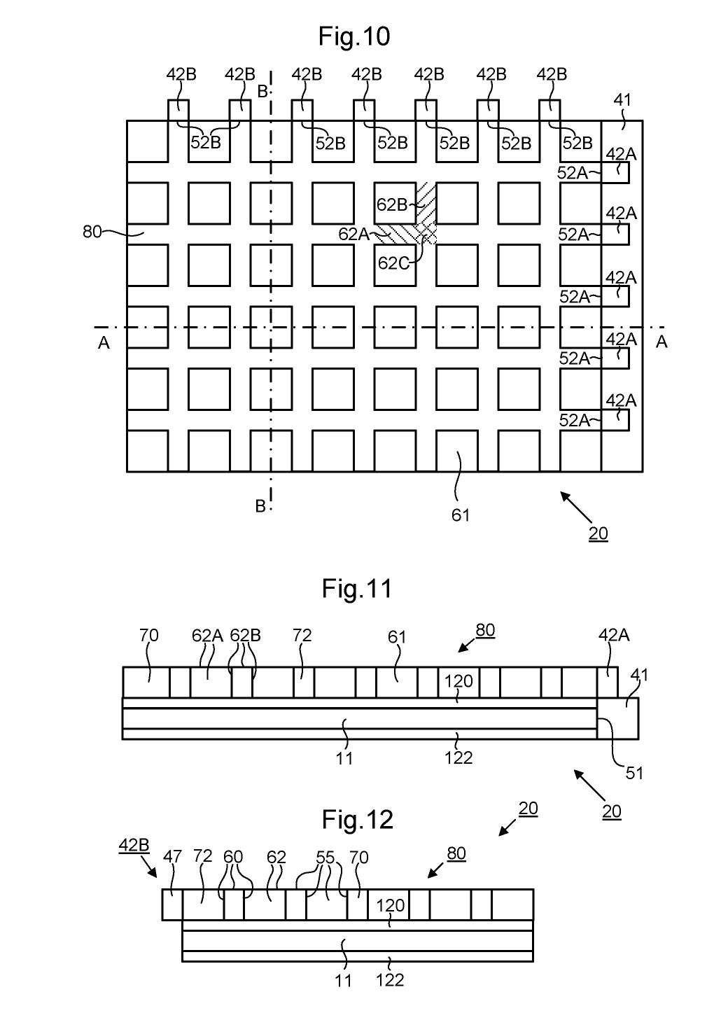

FIG. 10 is a schematic top view of a receiver for data communications according to a further embodiment, wherein the second concentration stage comprises first and second pluralities of elongate sub-elements which are non-parallel and integrally interconnected;

FIG. 11 is a schematic side sectional view along A-A in FIG. 10;

FIG. 12 is a schematic side sectional view along B-B in FIG. 10;

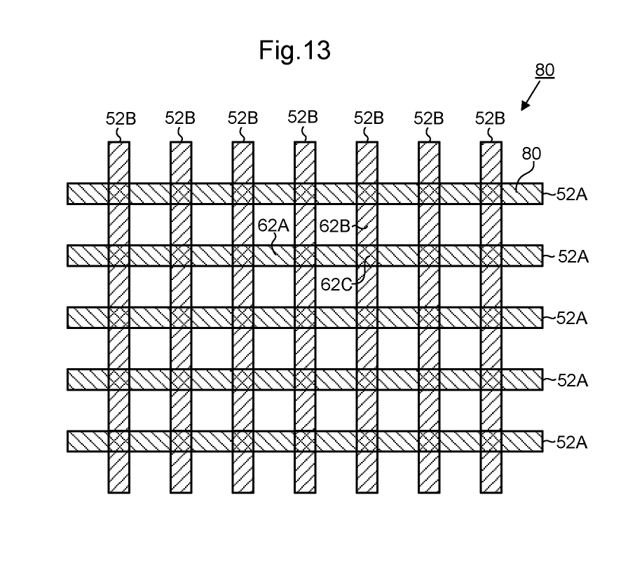

FIG. 13 is a schematic top view of the integrally interconnected first and second pluralities of elongate sub-elements showing regions comprising different fluorophores;

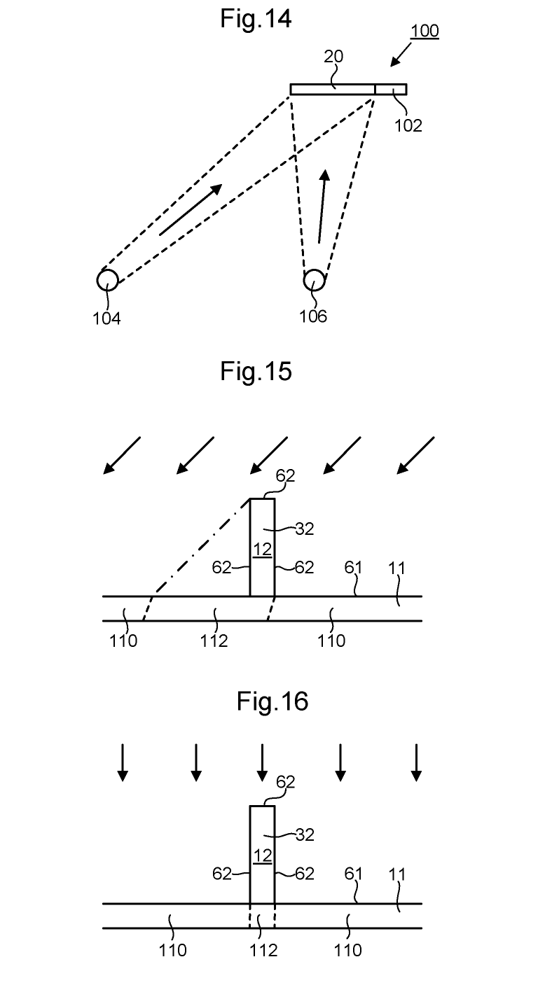

FIG. 14 depicts a receiver system and plurality of communication terminals;

FIG. 15 depicts shadowing of a portion of the first concentration stage by a concentration element of the second concentration stage for an oblique direction of incidence of radiation; and

FIG. 16 depicts shadowing in the arrangement of FIG. 15 in the case where the radiation is incident parallel to the normal.

In an embodiment, examples of which are described in further detail below with references to FIGS. 5-16, there is provided a receiver 20 for data communications. The receiver 20 comprises a first concentration stage. The first concentration stage receives radiation via a first input surface 61 and outputs concentrated radiation via one or more first output surfaces 51. The total area of the first output surfaces 51 is smaller than the area of the first input surface 61. The first concentration stage comprises a first wavelength converting element 11 that converts radiation to longer wavelength radiation. The first wavelength converting element 11 may for example absorb radiation at a first wavelength or wavelengths and re-emit the radiation at a second wavelength or wavelengths that is/are longer than the first. The spectrum of radiation is thus changed by shifting power from the first wavelength or wavelengths to the second wavelength or wavelengths.

In an embodiment, the first wavelength converting element 11 comprises a support body containing dispersed wavelength converting elements. The dispersed wavelength converting elements may comprise fluorescent dye. Alternatively, the dispersed wavelength converting elements may comprise quantum dot wavelength converters. The support body may comprise one or more of the following: an amorphous polymer, an inorganic glass, a SiO₂-based inorganic glass, an acrylic. In an embodiment, the first wavelength converting element 11 and/or support body is/are configured to be substantially transparent to converted radiation so as to reduce or minimize re-absorption losses. The support body may be configured so that a large proportion of converted radiation is retained within the support body by internal reflection until it reaches a detector.

In an embodiment, the first wavelength converting element 11 comprises a quantum dot wavelength converter. In an embodiment, the quantum dot wavelength converter comprises solution processed quantum dots. Solution processed quantum dots are particularly suitable for this application because they have tuneable absorption and emission characteristics, large luminescence quantum yields and Stokes shifts compatible with minimal re-absorption losses. In an embodiment the quantum dot wavelength converter comprises lead chalcogenide quantum dot wavelength converters.

In an embodiment, the first wavelength converting element 11 converts UV radiation to visible, infrared or near-infrared radiation. Alternatively or additionally, the first wavelength converting element 11 converts infrared or near-infrared radiation to other infrared or near-infrared radiation. Alternatively or additionally, the first wavelength converting element 11 converts visible radiation to other visible radiation or infrared or near-infrared. In one particular embodiment, the first wavelength converting element 11 absorbs radiation at approximately 475 nm and re-emits at approximately 600 nm, with a corresponding confinement structure being provided that substantially passes radiation having a wavelength of approximately 475 nm and traps radiation having a wavelength of approximately 600 nm. Such a system may be implemented using the dye Ru(BPY)3 for example. Many other dyes may be used. Alternatively or additionally, quantum dots may be used. For example, Qdot® (Life Technologies Corporation) quantum dots may be used, which are available in various different formats with different absorption and emission characteristics. Qdot® 605, or Qdot® 655, which have respective emission maxima of about 605 nm and about 655 nm may be used for example.

In an embodiment, the first wavelength converting element 11 has a thickness that is smaller than the length and/or width of the element. In an embodiment, the first wavelength converting element 11 is provided in a substantially sheet-like form, for example having a thickness that is at least 10 times, optionally at least 50 times, optionally at least 100 times, smaller than the length and/or width of the element. A large collection area in a relatively small volume device can thus be provided. In an example embodiment, the first wavelength converting element 11 is provided in a substantially planar form.

The wavelength conversion to longer wavelengths makes it possible to provide a wider field of view for a given level of gain or, conversely, a higher gain for a given field of view, than otherwise comparable étendue preserving concentrators.

The receiver 20 comprises one or more first detectors 41 that detect radiation output from the first concentration stage. Each of the first detectors 41 is sensitive to a selected range of wavelengths of interest. In the examples of FIGS. 5-12, the first concentration stage comprises a flat, substantially planar first wavelength converting element 11 and a confinement structure 120,122 formed from parallel plates sandwiching the first wavelength converting element 11. The confinement structure 120,122 increases internal reflection of radiation that has been converted to longer wavelength radiation by the first wavelength converting element 11. The confinement structure 120,122 may comprise dichroic plates for example.

In the examples shown, the first concentration stage has a relative large first input surface 61 provided by the upper surface of the planar first wavelength converting element 11 and upper plate of the confinement structure 120,122. A smaller first output surface 51 is provided by one of the side surfaces of the first wavelength converting element 11 (seen most clearly in FIGS. 6, 9 and 11). The one or more first detectors 41 detect radiation output from the first output surface 51. In the examples of FIGS. 5-12, the one or more first detectors 41 only detect radiation output from one of the four side surfaces of the first wavelength converting element 11. In this case internal reflection may be sufficient to prevent excessive loss of radiation via uncovered side surfaces. However, in an embodiment, an additional peripheral reflector may be provided to reduce losses at uncovered side surfaces. The peripheral reflector may be a broadband reflector such as a metal mirror. In an embodiment, a dichroic mirror is used as the peripheral reflector. In other embodiments, the one or more first detectors 41 may be configured to detect radiation output from more than one of the side surfaces, for example two, three, or all of the side surfaces. The one or more first detectors 41 may comprise a single photosensitive element (e.g. photodiode) or a group of photosensitive elements.

In an embodiment, the re-emission of the wavelength converted radiation within the first wavelength converting element 11 happens in all directions and reflections from the surface of the first wavelength converting element 11 and/or confinement structure (where provided) are effective to direct the radiation towards the one or more first detectors 41. In an embodiment, the geometry and dimensions of the first wavelength converting element 11 and/or confinement structure 120,122 determine the total surface area of the one or more first detectors 41 that receives radiation, and therefore determine, at least in part, the final concentration factor achieved by the first concentration stage. In the particular example shown, the surface area will be determined by the shape of the confinement structure 120,122 (e.g. rectangular), the separation between the plates forming the confinement structure 120,122 and the depth (into the page) of the confinement structure 120,122.

The receiver 20 further comprises a second concentration stage. The second concentration stage receives radiation via one or more second input surfaces 62. The second concentration stage outputs radiation via one or more second output surfaces 52. Example geometries for the second concentration stage are described below with reference to FIGS. 5-16. The second concentration stage comprises a second wavelength converting element 12 that converts radiation to longer wavelength radiation. The second wavelength converting element 12 may be configured to perform the wavelength conversion using any of the mechanisms described above in the context of the first wavelength converting element 11, and have a corresponding composition (e.g. fluorophores or quantum dots dispersed in a support body, with or without a confinement structure).

The receiver 20 further comprises one or more second detectors 42 that detect radiation output from the second concentration stage. The one or more second detectors 42 may detect radiation output from the one or more second output surfaces 52.

Optionally, the receiver 20 further comprises a third concentration stage. The third concentration stage receives radiation via one or more third input surfaces 63. The third concentration stage outputs radiation via one or more third output surfaces 53. Example geometries for the third concentration stage are described below with reference to FIGS. 8 and 9. The third concentration stage comprises a third wavelength converting element 13 that converts radiation to longer wavelength radiation. In such an embodiment the receiver 20 further comprises one or more third detectors 43 that detect radiation output from the third concentration stage. The one or more third detectors 43 may detect radiation output from the one or more third output surfaces 53. The third wavelength converting element 13 may be configured to perform the wavelength conversion using any of the mechanisms described above in the context of the first wavelength converting element 11, and have a corresponding composition (e.g. fluorophores or quantum dots dispersed in a support body, with or without a confinement structure).

Radiation output from a wavelength converting element 11,12,13 may be directed to one or more detectors 41,42,43 by reflection from a confinement structure 120,122 and/or from free (e.g. exposed to the environment) peripheral sides of the wavelength converting element 11,12,13. Each of any combination of the first, second and third concentration stages may comprise a confinement structure 120,122. The confinement structure 120,122 substantially allows passage of radiation having a wavelength suitable for conversion by a wavelength converting element 11,12,13 in the confinement structure from the outside of the confinement structure 120,122 to the inside of the confinement structure 120,122. The confinement structure 120,122 substantially blocks passage of radiation that has been converted by the wavelength converting element 11,12,13 from the inside of the confinement structure 120,122 to the outside of the confinement structure 120,122 (thus “confining” converted radiation within the confinement structure). The confinement structure 120,122 is depicted only around the first wavelength converting element 11 in the examples of FIGS. 5-13 but could alternatively or additionally be provided around any of the second and third wavelength converting elements 12,13 of the second and third concentration stages.

All or part of the confinement structure 120,122 may be omitted from any of the first, second and third concentration stages. In this case, radiation emitted by a wavelength converting element 11,12,13 may be directed towards one or more of the detectors 41,42,43 via internal reflections from at least one free surface of the wavelength converting element 11,12,13. Use of a confinement structure 120,122 or part of a confinement structure 120,122 (e.g. one of the plates of the confinement structure 120,122 shown in the Figures) will tend to favour lower losses. Omitting all or part of a confinement structure 120,122 from one or more of the concentration stages may facilitate manufacture and/or reduce cost. In a variation on the arrangements of FIGS. 5-13, the lower plate 122 of the confinement structure 120,122 may be omitted, for example, with adequate internal reflection being provided by an air interface at the lower surface of the receiver 20. It will usually be desirable to keep the upper plate 120 of the confinement structure 120, at least underneath individual concentration elements 32 of the second concentration stage, so as to control (e.g. substantially prevent) leakage of radiation from the second concentration stage to the first concentration stage.

Where the first concentration stage comprises a confinement structure 120,122, the confinement structure 120,122 may concentrate radiation towards the one or more first output surfaces 51 of the first concentration stage. Where the second concentration stage comprises a confinement structure, the confinement structure may concentrate radiation towards the one or more second output surfaces 52 of the second concentration stage. Where the third concentration stage comprises a confinement structure, the confinement structure may concentrate radiation towards the one or more third output surfaces 53 of the third concentration stage.

Where the first concentration stage comprises a confinement structure 120,122, the first wavelength converting element 11 may be located within the confinement structure 120,122. Where the second concentration stage comprises a confinement structure, the second wavelength converting element 12 may be located within the confinement structure. Where the third concentration stage comprises a confinement structure, the third wavelength converting element 13 may be located within the confinement structure.

The first and second concentration stages are arranged relative to each other such that a shadowing of the first concentration stage by the second concentration stage in respect of radiation incident on the receiver 20 varies as a function of a direction of incidence of the incident radiation. This variation causes a corresponding variation in the radiation detected by the first and second detectors 41,42 as a function of the direction of incidence.

The effect is illustrated schematically in FIGS. 15 and 16 for two directions of incidence. In these figures, a portion of the first concentration stage is represented by the planar, horizontal portion of a first wavelength converting element 11 in the lower part of the figure. The first input surface 61 is the upper surface of the first wavelength converting element 11. A portion of the second concentration stage is represented by an elongate concentration element 32 extending into the page. The concentration element 32 has a rectangular cross-section which is elongate and vertical (in the plane of the page). An outer surface of the concentration element 32 provides second input surfaces 62 (two side surfaces and a top surface) of the second concentration stage. FIG. 15 shows the case where radiation is incident on the first and second concentration stages at an oblique angle. The dot-chain lines show how the concentration element 32 casts a shadow on the underlying first wavelength converting element 11. Regions 110 of the first wavelength converting element 11 receive the incident radiation directly (i.e. are not in shadow). Region 112 is in the shadow of the concentration element 32 and will not receive the incidence radiation directly. Instead, radiation that would have entered the first wavelength converting element 11 if the concentration element 32 was not present will instead enter the concentration element 32 and potentially be wavelength converted and detected by a second detector 42. FIG. 16 shows the case where radiation is incident in a direction parallel to the normal. In this case the size of region 112 relative to regions 110 is clearly much smaller than in FIG. 15. Less of the first concentration stage is shadowed by the second concentration stage for this direction of incidence. The ratio of the amount of radiation detected by the one or more first detectors 41 to the amount of radiation detected by the one or more second detectors 42 will thus be larger in the arrangement of FIG. 16 than in the arrangement of FIG. 15, thereby providing information about the direction of incidence of radiation on the receiver.

More generally, the variation caused by the shadowing is desirably such as to improve the extent to which the receiver 20 can distinguish between radiation incident on the receiver 20 from transmitters at different locations. Each of the transmitters may be associated for example with an individual mobile device (such as a mobile telephone, tablet, etc.) desiring to communicate with the receiver 20 independently of any other mobile devices in the vicinity.

The nature of the variation can take many forms. As depicted in FIGS. 15 and 16, the variation may be such that a ratio of the amount of radiation received by the one or more first detectors 41 to the amount of radiation received by the one or more second detectors 42 is a function of the position of the transmitter (and therefore the direction of incidence of the incident radiation). The embodiment described below with reference to FIGS. 5-7 is an example of this type. In other embodiments, the nature of the variation may be more complex. Further concentration stages may be provided to allow more detailed information about the direction of incidence to be determined. Examples of this type are described below in further detail with reference to FIGS. 8-13.

In an embodiment, the second concentration stage comprises a plurality of concentration elements 32. Each of the concentration elements 32 may be configured to concentrate radiation and comprise a portion of the second wavelength converting element 12. Each of the concentration elements 32 may for example comprise a support body containing dispersed wavelength converting elements, as described above. Each of the concentration elements 32 has at least a portion with an elongate cross-section 124 (e.g. height greater than width) when viewed in a direction parallel to at least a portion of the first input surface 61 that is closest to the cross-section. All of the embodiments shown in FIGS. 5-13 are examples of this type. The geometry is labelled in FIG. 7, where the axis of elongation 126 (the direction parallel to the longest dimension of the cross-section 124) is shown for an example one of the concentration elements 32. Radiation incident on the receiver 20 in a direction that is parallel to the axis of elongation 126 of any such concentration element 32 will tend to be absorbed to a relatively small extent by the concentration element 32. The proportion of the radiation that is absorbed by the concentration element 32 will tend to increase quickly (and the proportion of the radiation that is absorbed by the first concentration stage will correspondingly decrease quickly) as the direction of incidence moves away from parallel, for most directions, thereby providing high sensitivity to changes in the direction of incidence.

In an embodiment, an axis of elongation 126 of the cross-section 124 is within 20 degrees of perpendicular, optionally within 10 degrees of perpendicular, optionally within 5 degrees of perpendicular, optionally substantially perpendicular, to the portion 128 of the first input surface 61 that is closest to the cross-section 124. Where all of the concentration elements 32 of the second concentration stage are configured in this way, radiation incident on the receiver 20 roughly perpendicularly will tend to be absorbed predominantly by the first concentration stage, while radiation incidence at more oblique angles will tend to be more evenly distributed between the first and second concentration stages, with the details of the distribution being determined by the particular direction of incidence.

In an embodiment, examples of which are shown in FIGS. 5-16, the first input surface 61 is substantially planar. This geometry may facilitate manufacture and/or positioning of the receiver 20 against flat objects such as walls or ceilings. Other arrangements are possible.

In an embodiment, an example of which is shown in FIGS. 5-7, the second concentration stage comprises a plurality of concentration elements 32 that are elongate and substantially parallel to each other when viewed perpendicularly to at least a portion of the first input surface 61. The variation in the absorption as a function of the direction of incidence of radiation onto the receiver 20 will tend to be the same for each of the parallel concentration elements 32. The combined output from all of the concentration elements may therefore provide a signal that is easy to interpret and in which there is a strong correlation with the direction of incidence, thereby facilitating the process of reliably and accurately distinguishing between radiation incident on the receiver 20 from different directions (and therefore potentially from different transmitters).

In the example of FIGS. 5-7, the second concentration stage comprises five concentration elements 32. Each of the concentration elements 32 is elongate when viewed perpendicularly to the first input surface 61 (in this case perpendicularly to the plane of the page in FIG. 5). The one or more second output surfaces 52 comprise five second output surfaces 52 provided by an end surfaces of each of the five concentration elements 32. Radiation output from each of the five second output surfaces 52 is received by a second detector 42. Each second detector 42 may comprise a single photosensitive element (e.g. a photodiode) or a group of photosensitive elements. The second detectors 42 can be read out independently of the first detectors 41, thereby allowing the receiver 20 to distinguish between radiation incident on the receiver 20 from different directions.

In an embodiment, the receiver 20 comprises a third concentration stage, as described above. The third concentration stage may be arranged relative to the first and second concentration stages such that a shadowing of either or both of the first and second concentration stages by the third concentration stage in respect of radiation incident on the receiver varies as a function of the direction of incidence of the incident radiation, thereby causing a corresponding variation in the radiation detected by the first, second and third detectors. Desirably, the variation as a function of direction of incidence of the shadowing by the second concentration stage is different to the variation as a function of direction of incidence of the shadowing by the third concentration stage. For example, the proportion of radiation detected by the one or more second detectors 42 relative to the radiation detected by the one or more third detectors 43 may be arranged to vary as a function of the direction of incidence of the incident radiation. The one or more second detectors 42 may be configured to detect radiation independently from the one or more third detectors 43, thereby allowing the receiver 20 to detect radiation output from the second concentration stage independently of radiation output from the third concentration stage. The third concentration stage may therefore provide further information about the direction of incidence of radiation on the receiver 20 and further assist the receiver with the task of distinguishing between radiation incident from different directions.

In an embodiment of this type, as illustrated for example in FIGS. 8-9, the second concentration stage comprises a plurality of concentration elements 32 that are elongate and substantially parallel to each other when viewed perpendicularly to at least a portion of the first input surface 61. Each concentration element 32 comprises a portion of the second wavelength converting element 12. The third concentration stage comprises a plurality of concentration elements 33 that are elongate and substantially parallel to each other when viewed perpendicularly to at least a portion of the first input surface 61. Each concentration element 33 comprises a portion of the third wavelength converting element 13. The plurality of concentration elements 32 of the second concentration stage are not parallel to the plurality of concentration elements 33 of the third concentration stage. In the particular example of FIGS. 8-9, the concentration elements 32 are substantially perpendicular to the concentration elements 33.

In the example of FIGS. 8-9, the second output surfaces 52 comprise an end surface of each of the concentration elements 32. The third output surfaces 53 comprise an end surface of each of the concentration elements 33.

A given plurality of parallel elongate concentration elements will tend to be most sensitive to variations in an angle of incidence of radiation within a given plane. Providing pluralities of parallel elongate concentration elements which are aligned in different directions allows the receiver 20 to be sensitive to variations in the angle of incidence in multiple planes. For example, in the case of FIG. 8, it can be seen that the concentration elements 32 of the second concentration stage are sensitive to variations in the angle of incidence of radiation that are within a plane that is perpendicular to the page and vertical (and the concentration elements 33 of the third concentration stage are substantially insensitive to variations in the angle of incidence of radiation within that plane). Similarly, the elongate concentration elements 33 of the third concentration stage are sensitive to variations in the angle of incidence of radiation that are within a plane that is perpendicular to the page and horizontal (and the elongate concentration elements 32 of the first concentration stage are substantially insensitive to variations in the angle of incidence of radiation within that plane). Thus, a shadowing of the first concentration stage by the concentration elements 32 of the second concentration stage would vary most when a distant transmitter moves in a vertical direction parallel to the plane of the page in FIG. 8. A shadowing of the first and/or second concentration stage by the concentration elements 33 of the third concentration stage would vary most when a distant transmitter moves in a horizontal direction parallel to the plane of the page in FIG. 8.

In an embodiment of this type the concentration elements 32 of the second concentration stage overlap with the concentration elements 33 of the third concentration stage when viewed perpendicularly to at least a portion of the first input surface 61. As can be seen in FIG. 9, this is achieved in the example of FIGS. 8-9 by arranging for the concentration elements 32 to be in a different plane to (i.e. below) the concentration elements 33.

In an embodiment, an example of which is depicted in FIGS. 10-13, the one or more second input surfaces 62 comprises plural sets of second input surfaces 62A,62B,62C. Each set comprises one or a plurality of second input surfaces. The second wavelength converting element 12 converts radiation input through a first set 62A of the plural sets of second input surfaces 62A,62B,62C to longer wavelength radiation that is predominantly of a first type. A single example second input surface of the first set 62A is indicated by a horizontal, hatched region in FIG. 10. The second wavelength converting element 12 further converts radiation input through a second set 62B of the plural sets of second input surfaces 62A,62B,62C to longer wavelength radiation that is predominantly of a second type. A single example second input surface of second set 62B is indicated by a vertical, hatched region in FIG. 10. The first type of longer wavelength radiation is different from the second type of longer wavelength radiation, for example having a different wavelength or spectrum. In other embodiments, more than two sets of the second input surfaces may be configured to convert radiation differently relative to each other (e.g. to different wavelengths or spectra), for example three sets, four sets or five sets. The one or more second detectors 42A,42B can be configured to distinguish between radiation having different wavelengths or spectra and can thereby distinguish between radiation that has entered the second concentration stage via different sets of the second input surfaces 62A,62B,62C. The conversion of radiation to longer wavelength radiation of different types can be implemented in various ways. In one embodiment, the second wavelength converting element 12 uses different fluorophores, for example a first fluorophore to convert to the longer wavelength radiation of the first type and a second fluorophore, different from the first fluorophore, to convert to the longer wavelength radiation of the second type.

The relative proportion of longer wavelength radiation of the first type to longer radiation of the second type detected by the one or more second detectors 42A,42B may be arranged to vary as a function of the direction of incidence of the incident radiation. This may be achieved for example by arranging for the ratio of the total surface area, viewed along the direction of incidence of the radiation, of the first set 62A of second input surfaces to the total surface, viewed along the direction of incidence of the radiation, of the second set 62B of second input surfaces to vary as a function of the direction of incidence of the incident radiation. This property, when combined with an ability to distinguish between radiation of different types (different wavelengths or spectra) helps the receiver 20 distinguish reliably and/or in a detailed manner between radiation incidence on the receiver 20 from different directions of incidence.

In an embodiment, the second concentration stage comprises a concentration element 80 comprising a first plurality of elongate sub-elements 70 and a second plurality of elongate sub-elements 72 (labelled 70 and 72 in FIGS. 11 and 12). In the example of FIGS. 10-13, the elongate sub-elements intersect to form a waffle-like structure. The first plurality of elongate sub-elements 70 correspond to the portions of the concentration element 80 that provide the first set 62A of second input surfaces. The second plurality of elongate sub-elements 72 correspond to the portions of the concentration element 80 that provide the second set 62B of second input surfaces. In an embodiment, the second wavelength converting element 12 is configured such that the conversion of radiation to longer wavelength radiation predominantly provides radiation of a different type in the first plurality of elongate sub-elements 70 than in the second plurality of elongate sub-elements 72. In the example of FIGS. 10-13, each of the sub-elements 70 comprise a first fluorophore and each of the sub-elements 72 comprise a second fluorophore. In the example of FIGS. 10-13, a third set 62C of second input surfaces are provided by a further plurality of sub-elements forming regions of integral interconnection between the first and second pluralities of elongate sub-elements 70,72. In this embodiment the further plurality of sub-elements may comprise a mixture of both of the first and second fluorophores.

In an embodiment, the first plurality of elongate sub-elements 70 are substantially parallel to each other when viewed perpendicularly to at least a portion of the first input surface 61. The second plurality of elongate sub-elements 72 are substantially parallel to each other when viewed perpendicularly to at least a portion of the first input surface 61. The first plurality of elongate sub-elements 70 are not parallel to the second plurality of elongate sub-elements 72 when viewed perpendicularly to at least a portion of the first input surface 61. The first plurality of elongate sub-elements 70 are integrally interconnected with the second plurality of elongate sub-elements 72. In the example of FIGS. 10-13 the integral interconnection is provided by the further plurality of sub-elements providing the third set 62C of second input surfaces.

The distribution of first, second and third sets of second input surfaces 62A-C are shown most clearly in FIG. 13, for the particular example of FIGS. 10-13. The first set of second input surfaces 62A consists of all of the hatched regions that are horizontal. The second set of second input surfaces 62B consists of all of the hatched regions that are vertical. The third set of second input surfaces 62C consists of all of the cross-hatched regions which integrally link together the second input surfaces 62A and 62B of the first and second sets.

In this embodiment the one or more second output surfaces comprise a first set of second output surfaces 52A and a second set of second output surfaces 52B. The one or more second detectors comprises a first set of detectors 42A for detecting radiation output from the first set of second output surfaces 52A and a second set of detectors 42B for detecting radiation output from the second set of second output surfaces 52B. Radiation incident onto the first set 62A of second input surfaces will tend predominantly to travel to the second output surfaces 52A. Radiation incident onto the second set 62B of second input surfaces will tend predominantly to travel to the second output surfaces 52B. Radiation incident onto the third set 62C of second input surfaces may travel to either or both of the second output surfaces 52A and 52B. Thus, the second detectors 42A will predominantly detect radiation that has been converted to longer wavelength radiation of the first type and the second detectors 42B will predominantly detect radiation that has been converted to longer wavelength radiation of the second type.

In an embodiment a reflective layer 90 (e.g. metallic) is provided in between at least a portion of the second concentration stage and at least a portion of the first concentration stage and/or between at least a portion of the third concentration stage and at least a portion of the second concentration stage, in order to enhance the shadowing of the first concentration stage by the second concentration stage or of the second concentration stage by the third concentration stage. Such a reflective layer 90 can be provided in any of the embodiments discussed above and in other embodiments. An example of how the reflective layer 90 may be configured is shown in FIG. 9 for the example of FIGS. 8-9. The reflective layer 90 is provided beneath each of the concentration elements 32 of the second concentration stage and beneath each of the concentration elements 33 of the third concentration stage.

FIG. 14 depicts a receiver system 100 comprising a receiver 20 according to any embodiment of the invention. The receiver system 100 further comprises a decoder 102. A plurality of communication terminals 104,106 are provided, each positionable at a different location relative to the receiver system 100 and each being configured to transmit radiation to the receiver system 100. The decoder 102 is configured to obtain first information independently from second information, wherein the first information originates from radiation incident on the receiver 20 in a first range of directions of incidence (e.g. from a first one 104 of the plurality of communication terminals 104,106) and the second information originates from radiation incident on the receiver 20 in a second range of directions of incidence, different from the first range of directions of incidence (e.g. from a second one 106 of the plurality of communication terminals 104,106).

Listing of claims:

1. A receiver for data communications, comprising:
a first concentration stage configured to receive radiation via a first input surface and output concentrated radiation via one or more first output surfaces, the first concentration stage comprising a first wavelength converting element configured to convert radiation to longer wavelength radiation;
one or more first detectors configured to detect radiation output from the first concentration stage;
a second concentration stage configured to receive radiation via one or more second input surfaces and output radiation via one or more second output surfaces, the second concentration stage comprising a second wavelength converting element configured to convert radiation to longer wavelength radiation; and
one or more second detectors configured to detect radiation output from the second concentration stage, wherein
the first and second concentration stages are arranged relative to each other such that a shadowing of the first concentration stage by the second concentration stage in respect of radiation incident on the receiver varies as a function of a direction of incidence of the incident radiation, thereby causing a corresponding variation in the radiation detected by the first and second detectors as a function of the direction of incidence.

2. The receiver of claim 1, wherein:
the second concentration stage comprises a plurality of concentration elements that each have at least a portion with an elongate cross-section when viewed in a direction parallel to a portion of the first input surface that is closest to the cross-section; and
an axis of elongation of the elongate cross-section is within 20 degrees of perpendicular to the portion of the first input surface that is closest to the cross-section.

3. The receiver of claim 1, wherein the first input surface is substantially planar.

4. The receiver of claim 1, wherein the second concentration stage comprises a plurality of concentration elements that are elongate and substantially parallel to each other when viewed perpendicularly to at least a portion of the first input surface.

5. The receiver of claim 1 any preceding claim, further comprising:
a third concentration stage configured to receive radiation via one or more third input surfaces and output radiation via one or more third output surfaces, the third concentration stage comprising a third wavelength converting element configured to convert radiation to longer wavelength radiation, and
one or more third detectors configured to detect radiation output from the third concentration stage, wherein:
the third concentration stage is arranged relative to the first and second concentration stages such that a shadowing of either or both of the first and second concentration stages by the third concentration stage in respect of radiation incident on the receiver varies as a function of the direction of incidence of the incident radiation, thereby causing a corresponding variation in the radiation detected by the first, second and third detectors.

6. The receiver of claim 5, wherein the variation as a function of direction of incidence of the shadowing by the second concentration stage is different to the variation as a function of direction of incidence of the shadowing by the third concentration stage.

7. The receiver of claim 5, wherein:
the second concentration stage comprises a plurality of concentration elements that are elongate and substantially parallel to each other when viewed perpendicularly to at least a portion of the first input surface;
the third concentration stage comprises a plurality of concentration elements that are elongate and substantially parallel to each other when viewed perpendicularly to at least a portion of the first input surface; and
the plurality of concentration elements of the second concentration stage are not parallel to the plurality of concentration elements of the third concentration stage.

8. The receiver of claim 5, wherein the one or more second detectors are configured to detect radiation independently from the one or more third detectors, thereby allowing the receiver to detect radiation output from the second concentration stage independently of radiation output from the third concentration stage, and allowing the receiver to detect radiation output from the third concentration stage independently of radiation output from the second concentration stage.

9. The receiver of claim 8, wherein the proportion of radiation detected by the one or more second detectors relative to the radiation detected by the one or more third detectors varies as a function of the direction of incidence of the incident radiation.

10. The receiver of claim 1, wherein:
the one or more second input surfaces comprise plural sets of second input surfaces, each set of second input surfaces comprising one or more second input surfaces;
the second wavelength converting element is configured to convert radiation input through a first set of the plural sets of second input surfaces to longer wavelength radiation that is predominantly of a first type;
the second wavelength converting element is configured to convert radiation input through a second set of the plural sets of second input surfaces to longer wavelength radiation that is predominantly of a second type, different from the first type; and
the relative proportion of longer wavelength radiation of the first type to longer radiation of the second type detected by the one or more second detectors varies as a function of the direction of incidence of the incident radiation.

11. The receiver of claim 1, wherein:
the second concentration stage comprises a concentration element comprising a first plurality of elongate sub-elements and a second plurality of elongate sub-elements;
the first plurality of elongate sub-elements are substantially parallel to each other when viewed perpendicularly to at least a portion of the first input surface;
the second plurality of elongate sub-elements are substantially parallel to each other when viewed perpendicularly to at least a portion of the first input surface;
the first plurality of elongate sub-elements are not parallel to the second plurality of elongate sub-elements when viewed perpendicularly to at least a portion of the first input surface; and
the first plurality of elongate sub-elements are integrally interconnected with the second plurality of elongate sub-elements.

12. The receiver of claim 11, wherein the second wavelength converting element is configured such that the conversion of radiation to longer wavelength radiation predominantly provides radiation of a different type in the first plurality of elongate sub-elements than in the second plurality of elongate sub-elements.

13. The receiver of claim 1, wherein a reflective layer is provided in between at least a portion of the second concentration stage and at least a portion of the first concentration stage or between at least a portion of the third concentration stage, where provided, and at least a portion of the second concentration stage, in order to enhance the shadowing of the first concentration stage by the second concentration stage or of the second concentration stage by the third concentration stage.

14. The receiver of claim 1, wherein each of one or more of the first, second and third concentrations stages comprises a confinement structure configured substantially to allow passage of radiation having a wavelength suitable for conversion by a wavelength converting element in the confinement structure, from the outside of the confinement structure to the inside of the confinement structure, and substantially to block passage of radiation that has been converted by the wavelength converting element from the inside of the confinement structure to the outside of the confinement structure.

15. The receiver of claim 1 in which each of one or more of the first, second and third wavelength converting elements is configured to do one or more of the following: convert infrared or near-infrared radiation to infrared radiation or near-infrared radiation having a longer wavelength, convert UV radiation to visible radiation, convert UV radiation to infrared or near-infrared radiation, convert visible radiation to visible radiation having a longer wavelength, and convert visible radiation to infrared or near-infrared radiation.

16. A receiver system comprising:
the receiver of claim 1; and
a decoder configured to obtain information from radiation received by the one or more first detectors, the one or more second detectors, and where provided, the one or more third detectors.

17. The receiver system of claim 16, wherein the decoder is configured to obtain first information independently from second information, wherein the first information originates from radiation incident on the receiver in a first range of directions of incidence and the second information originates from radiation incident on the receiver in a second range of directions of incidence, different from the first range of directions of incidence.

18. A data communications system, comprising:
the receiver system of claim 16; and
a plurality of communication terminals each positionable at a different location relative to the receiver system and each being configured to transmit radiation to the receiver system.

19. (canceled)
